(19) United States
(12) Patent Application Publication
(10) Pub. No.: US 2011/0067842 A1
(43) Pub. Date: Mar. 24, 2011

(54) FLUID ENCAPSULATED HEAT TRANSFER VESSEL AND METHOD

(75) Inventors: Levi A. CAMPBELL, Poughkeepsie, NY (US); Richard C. CHU, Hopewell Junction, NY (US); Michael J. ELLSWORTH, Jr., Lagrangeville, NY (US); Madhusudan K. IYENGAR, Woodstock, NY (US); Robert E. SIMONS, Poughkeepsie, NY (US)

(73) Assignee: INTERNATIONAL BUSINESS MACHINES CORPORATION, Armonk, NY (US)

(21) Appl. No.: 12/564,199

(22) Filed: Sep. 22, 2009

(51) Int. Cl. F28D 15/00; A47J 36/00; B21D 53/02

(52) U.S. Cl. 165/104.21; 220/573.1; 29/890.03; 29/890.032

(57) ABSTRACT

A heat transfer vessel is provided which facilitates heating of a substance when disposed therein. The vessel is a partially hollow structure which includes a chamber formed between an outer shell and an inner shell, in base and sidewall portions of the vessel. A heat transfer fluid is disposed within the chamber to facilitate transfer of heat from the outer shell to the inner shell, and therefore, to a substance when disposed within the vessel. The heat transfer fluid is a two-phase encapsulated fluid with a liquid state which undergoes boiling with the application of heat to the outer shell and a vapor state which condenses with contact to the inner shell, thereby facilitating transfer of heat from the outer shell to the inner shell, and hence to the substance when disposed within the vessel.

### BACKGROUND

The present invention relates in general to heat transfer mechanisms, and more particularly, to heat transfer vessels for containing and facilitating heating of a substance.

Heating of a substance, such as liquid or a solid, whether for cooking purposes or laboratory or industrial applications, consumes significant energy in the United States and worldwide. Numerous examples of commercial heating vessels exist today. Unfortunately, there are many sources of energy inefficiencies in the heating of a substance using commercially available heating vessels. These inefficiencies include: a large temperature reduction between the region where heat is applied and portions of distant vessel surfaces also being used for heating; a heat loss from the exterior sidewall surfaces of the heating vessel to the ambient air; and a lack of heating surface area in the large central volume of the substance being heated.

### BRIEF SUMMARY

In one aspect, the shortcomings of the prior art are overcome and additional advantages are provided through the provision of a device comprising a heat transfer vessel to facilitate heating of a substance. The heat transfer vessel includes an at least partially hollow structure comprising a chamber formed between an outer shell and an inner shell thereof, and includes a base portion and a sidewall portion extending from the base portion, wherein the chamber is disposed within at least one of the base portion or the sidewall portion. The device further includes a heat transfer fluid disposed within the chamber of the heat transfer vessel, wherein the heat transfer fluid facilitates transfer of applied heat from the outer shell of the heat transfer vessel to the inner shell of the heat transfer vessel, and thus to the substance when disposed within the heat transfer vessel.

In a further aspect, a method of fabricating a heat transfer vessel is provided. The method includes: forming an at least partially hollow structure comprising a chamber defined between an outer shell and an inner shell thereof, and comprising a base portion and a sidewall portion extending from the base portion, the chamber being disposed within at least one of the base portion or the sidewall portion of the hollow structure; and disposing a heat transfer fluid within the chamber of the hollow structure, the heat transfer fluid facilitating transfer of heat applied to the outer shell of the heat transfer vessel to the inner shell of the heat transfer vessel, and thus, to a substance when disposed within the heat transfer vessel in contact with the inner shell thereof.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a schematic of a conventional heating vessel containing a substance undergoing heating through the application of heat to the bottom surface of the heating vessel;

FIG. 2 is a schematic of one embodiment of a heat transfer vessel comprising a heat transfer fluid encapsulated within a chamber thereof, in accordance with an aspect of the present invention;

FIG. 3 is a schematic of an alternate embodiment of a heat transfer vessel comprising a heat transfer fluid encapsulated within a compartment thereof, and comprising an insulative structure surrounding the outer shell of the vessel along the sidewall portion thereof, in accordance with an aspect of the present invention;

FIG. 4 depicts operational heating of the heat transfer vessel of FIG. 3, illustrating thermal energy transfer from the outer shell of the heat transfer vessel to the inner shell of the vessel employing boiling and condensation of the heat transfer fluid within the chamber of the vessel, in accordance with an aspect of the present invention;

FIG. 5 is a schematic of an alternate embodiment of a heat transfer vessel comprising a heat transfer fluid encapsulated within a chamber of the vessel, in accordance with an aspect of the present invention; and

FIGS. 6A & 6B depict further alternate embodiments of a heat transfer vessel, each comprising a heat transfer fluid encapsulated within a chamber of the vessel, in accordance with an aspect of the present invention.

### DETAILED DESCRIPTION

Disclosed herein is a novel three-dimensional device which addresses the above-noted drawbacks of commercially available heating vessels, and enables highly efficient heating of substances. As used herein, “substance” refers to any material to undergo heating, whether in liquid state, solid state or even gaseous state (with appropriate configuration of the device). The device disclosed herein provides high efficiency transfer of thermal energy from an externally heated surface to an inner surface (where the energy is desired) through a boiling and condensation heat transfer loop. With proper selection of the encapsulated heat transfer fluid and the encapsulation conditions (e.g., pressure) while keeping non-condensable gases within the vessel chamber to a minimum, a heat transfer vessel is attained which can operate within any desired temperature range for general heating applications, including cooking. Advantageously, the device disclosed herein uniquely provides a highly uniform, high-speed response to the external application of heat, and has many domestic and laboratory applications.

The heat transfer fluid employed within the heat transfer vessel is selected to possess the appropriate thermophysical properties that suit the particular heating application. Significant application parameters include the temperature of heat input via the outer shell, the heat flux of the heat input, the temperature desired at the inner shell in contact with the substance to be heated, and the expected heat transfer coefficient between the substance being heated and the inner shell of the vessel. The thermophysical fluid properties of interest for a range of temperature and pressure conditions are the boiling point of the liquid, the latent heat of vaporization, the surface tension, the specific heat, and the density in both liquid and vapor states.

For example, if the application is to heat a liquid substance to a temperature of 75° C. using a heat input at an outer shell temperature of 200° C., then the encapsulated fluid would have to boil at a temperature below 200° C. and condense at a temperature above 75° C., and would need to cycle between the vapor and liquid states for the application conditions (i.e., the heating and cooling heat transfer coefficients and the temperatures at heat input and heat rejection surfaces, respectively). For this example, since water under atmospheric conditions boils at about 100° C., pressurized water could be used to ensure that the boiling and condensation processes occur in the 200-75° C. temperature range, respectively, for the pressures experienced by the encapsulated fluid. If the boiling-condensation temperature range of interest is 80-40° C., then water at sub-atmospheric pressure could be used.

Other heat transfer fluids could be used depending on the application parameters. For example, dielectric coolants such as those manufactured by 3M Corporation under the brand names HFE-7000, HFE-7100, HFE-7200, HFE-7500, FC-87, FC-72, FC-70, FC-40 or refrigerants or oils could be used as the heat transfer fluid. Further, as noted above, pressure within the chamber can be manipulated to achieve the desired saturation conditions for a given heat transfer fluid.

As used herein, “heat transfer fluid” refers to any encapsulated fluid within the compartment of the vessel capable of repeated phase cycling between liquid and vapor states through boiling and condensation as explained herein.

Reference is made below to the drawings (which are not drawn to scale to facilitate understanding of the invention), wherein the same reference numbers used throughout different figures designate the same or similar components.

Briefly, FIG. 1 illustrates a conventional heating vessel 100 which comprises a solid-walled container of any desired shape for holding a substance 120 to be heated. Traditionally, substance 120 undergoes heating via the application of heat 130 to a bottom surface of container 110. By way of example, container 110 might comprise an aluminum, copper, stainless steel, glass, etc., cooking, laboratory or industrial processes vessel.

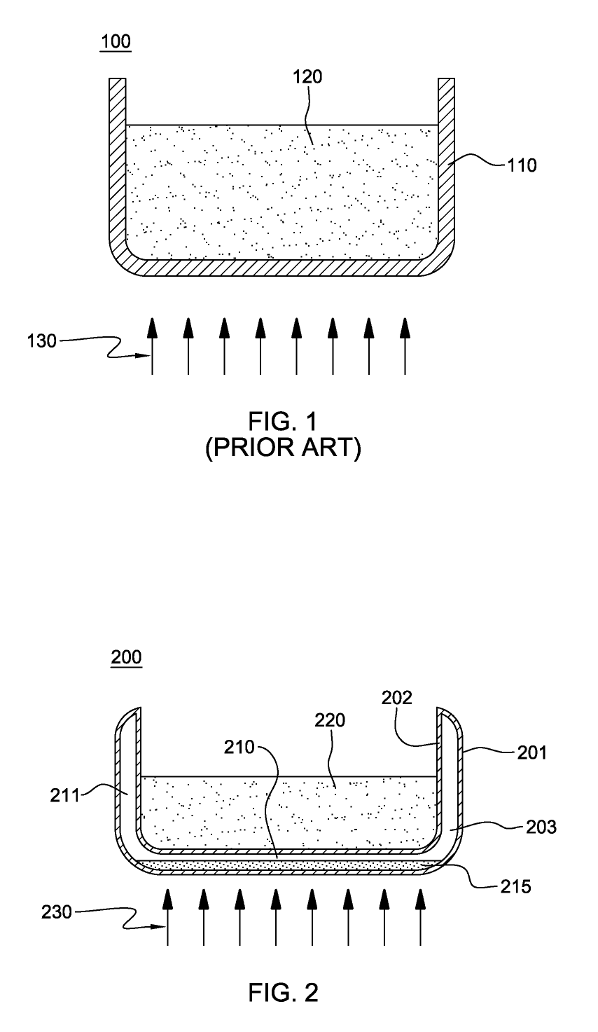

FIG. 2 illustrates one embodiment of a heat transfer vessel 200, in accordance with an aspect of the present invention. In this embodiment, heat transfer vessel 200 comprises an outer shell 201 and an inner shell 202 spaced apart to form a chamber 203 between opposing surfaces thereof. As illustrated, chamber 203 resides, in one embodiment, in both a base portion 210 and a sidewall portion 211 of the heat transfer vessel. A heat transfer fluid 215 in liquid state partially fills chamber 203, residing in base portion 210 of heat transfer vessel 200 as illustrated. Although not shown, one or more ports can be provided within the vessel extending into the chamber for facilitating evacuation of the chamber and disposition of the heat transfer fluid 215 within the chamber. The heat transfer fluid is a two-phase encapsulated fluid that may, at any point in time, be partially in liquid state and partially in vapor state. As noted above, various fluids could be employed for the heat transfer fluid, depending on desired thermophysical properties for a particular heating application or range of applications.

Heat transfer vessel 200 is thus a fluid encapsulated vessel, with enhanced energy efficient heating. In one embodiment, the vessel is cylindrical-shaped, although various shapes could be employed. As shown, the vessel is configured to hold or contain a substance 220, such as a liquid, to undergo heating by the application of external heat 230, for example, to a bottom surface of the vessel. With the application of heat, heat transfer fluid 215 repeatedly phase cycles transferring heat from outer shell 201 to inner shell 202, as explained further below. The surfaces of inner shell 201, both within chamber 203 and externally, in contact with substance 220, are the primary surfaces for heat exchange between the heat transfer fluid and the substance, that is, between the substance being heated and the encapsulated two-phase fluid that spreads and transports the heat away from the heated surface of base portion 210 to the larger surface area of inner shell 202 in contact with substance 220. Advantageously, the vaporized heat transfer fluid within chamber 203 efficiently and uniformly spreads this thermal energy to inner shell 202.

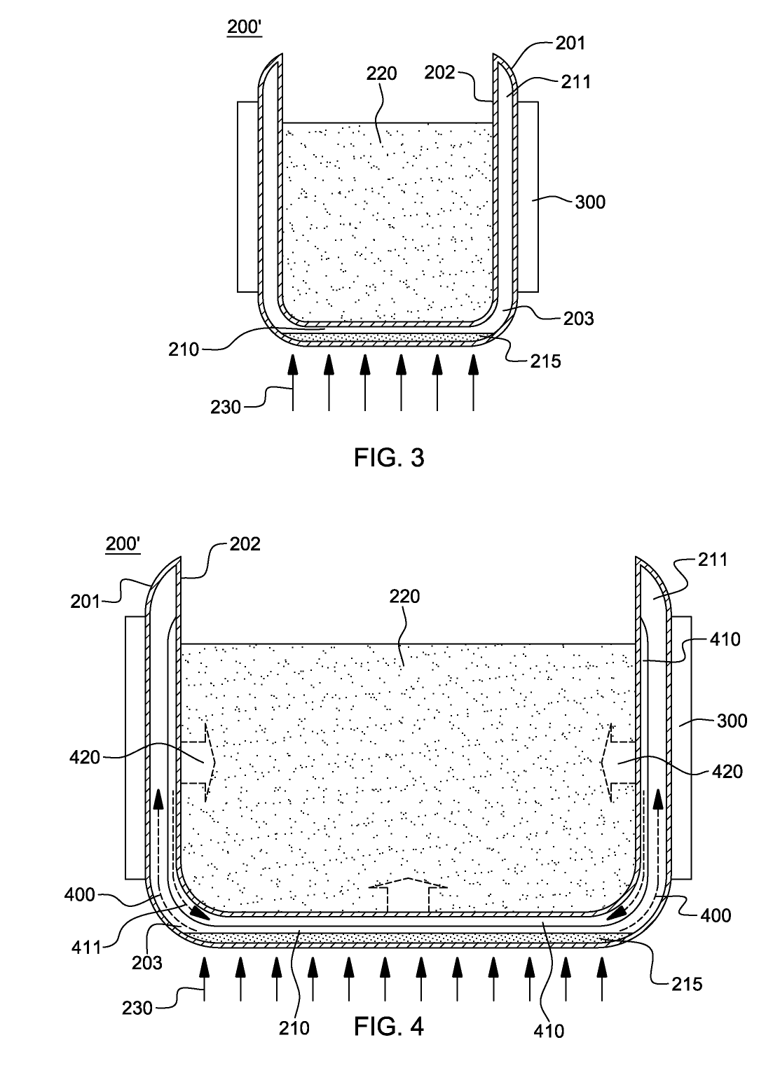

FIG. 3 illustrates an alternate embodiment of a heat transfer vessel 200′, which is substantially identical to heat transfer 200 of FIG. 2, with the exception of a reconfiguration to provide a smaller base portion 210 and a larger sidewall portion 211. As shown, outer shell 201 is in spaced opposing relation to inner shell 202 to define chamber 203, within which heat transfer fluid 215 resides. With the application of heat 230 to the bottom surface of vessel 200′, heat transfer fluid 215 in liquid state boils and the vaporized heat transfer fluid subsequently condenses along inner shell 202, transferring thermal energy to inner shell 202, both along the bottom portion 210 and the sidewall portion 211 of the vessel.

In this embodiment, an insulator 300 is attached to at least partially encircle outer shell 201 at the sidewall portion thereof. This insulator significantly reduces heat loss along the outer shell of the heat transfer vessel due to radiation cooling to ambient surroundings, natural air convection, or forced air convection in cases where there is a mechanically induced draft in the ambient surroundings. In one example, insulator 300 is an insulating jacket that is applied separately to outer shell 201, or alternatively, is an insulative structure that is integrated with outer shell 201. Insulator 300 would be most effective when heat transfer vessel 200′ is relatively tall, that is, has a relatively large sidewall portion 211, and the ratio of the surface area exposed to potential heat loss to the total external surface area is relatively large.

FIG. 4 is an operational example of heat transfer vessel 200′ of FIG. 3. When no heat source is applied, heat transfer vessel 200′ is non-operational, and the heat transfer fluid 215 exists in an equilibrium condition, with the liquid portion within chamber 203 remaining liquid and the vapor portion within chamber 203 remaining vapor. When the base of the heat transfer vessel 200′ is heated 230 (using some form of a heat source such as an electrical heater coil, or a flame), heat transfer fluid 215 in liquid state that was in equilibrium starts to boil, and its vapor travels through chamber 203, contacting the inner surfaces of inner shell 202 (within both base portion 210 and sidewall portion 211). As illustrated by arrows 400 in FIG. 4, a portion of this vaporized heat transfer fluid rises within chamber 203 into sidewall portions 211 of heat transfer vessel 200′. The substance 220 within the vessel being heated cools one side of inner shell 202, thus condensing the encapsulated vaporized heat transfer fluid on the other side of inner shell 202, that is, the surface of inner shell 202 exposed to chamber 203. This condensate forms a film 410 over the horizontal and vertical surfaces of the inner shell. The condensate film 410 flows as illustrated by arrows 411 along the inside surface of inner shell 202 and falls as droplets (not shown) back to the pool of boiling heat transfer fluid 215 in liquid state in base portion 210 of the vessel. The process continues until the desired amount of heat has been transferred to substance 220 from applied heat 230. Note that the result is a superior, more uniform spreading of heat 420 into substance 220 contained within the vessel.

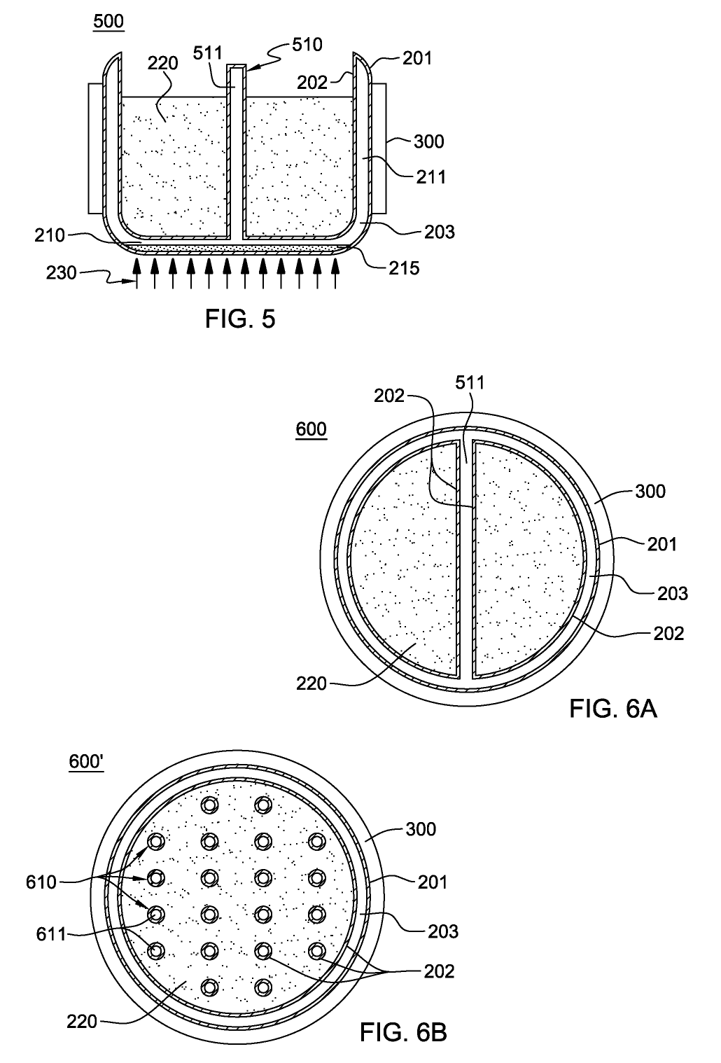

FIG. 5 illustrates an alternate embodiment of a heat transfer vessel 500, in accordance with an aspect of the present invention. Heat transfer vessel 500 is similar to the vessels described above in connection with FIGS. 3 & 4, however, includes the addition of one or more protrusions 510 in inner shell 202 into the central region of the vessel holding substance 220. As shown, chamber 203 defined between inner shell 202 and outer shell 201 extends in this embodiment within sidewall portion 211, base portion 210 and a protrusion portion(s) 511. This vessel configuration advantageously enhances the available surface area of inner shell 202 for heating substance 220 employing heat transfer fluid 215 and the application of heat 230 to the vessel. As illustrated, insulator 300 is provided at least partially surrounding the exposed exterior surface of outer shell 201 to limit parasitic heat loss to the ambient environment. Advantageously, the heat transfer vessel configuration of FIG. 5 allows a larger volume of substance 220 to be in contact with the hot surface of inner shell 202.

FIGS. 6A & 6B depict further alternate embodiments of heat transfer vessels, in accordance with aspects of the present invention. In FIG. 6A, a heat transfer vessel 600 is illustrated in cross-sectional plan view as comprising a circular-shaped vessel (presented by way of example only). Heat transfer vessel 600 includes outer shell 201 and inner shell 202 in spaced opposing relation to define chamber 203, within which is located a two-phase heat transfer fluid (not shown) such as described above. An insulator 300 surrounds the sidewall portion of outer shell 201, and in this embodiment, a rib-shaped central protrusion is provided within inner shell 202, resulting in chamber 203 also having a central protrusion portion 511 into which vaporized heat transfer fluid can rise, such as illustrated in FIG. 5. The result is an increased surface area of inner shell 202 exposed to substance 220 contained within the vessel.

FIG. 6B depicts a further embodiment of a heat transfer vessel 600′, wherein multiple protrusions 610 in inner wall 202 are shown in cross-sectional plan view. Each protrusion 610 is a cylindrical-shaped protrusion extending from a lower portion of inner shell 202 upwards into the central region of the vessel holding substance 220 to be heated. The cylindrical-shaped protrusions 610 in inner shell 202 result in multiple protrusion portions 611 being defined within chamber 203 (i.e., defined between outer shell 201 and inner shell 202 of the vessel). Heat transfer fluid in vapor state rises, in part, within the protrusion portions and is condensed upon contacting the surfaces of the inner shell, which are in thermal contact with the cooler substance 220, to then drop back down in liquid state into the base portion of the vessel for further boiling. Advantageously, the multiple protrusions 610 in inner surface 202 enhance the heat transfer surface area of inner shell 202. In this embodiment, an insulator 300 again at least partially encircles the sidewall portion of outer shell 201 to limit parasitic heat loss through the outer shell.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A device comprising:
a heat transfer vessel for facilitating heating of a substance when disposed therein, the heat transfer vessel being an at least partially hollow structure comprising a chamber formed between an outer shell and an inner shell thereof, and comprising a base portion and a sidewall portion extending from the base portion, the chamber being disposed within at least one of the base portion or the sidewall portion; and
a heat transfer fluid disposed within the chamber of the heat transfer vessel, the heat transfer fluid facilitating transfer of applied heat from the outer shell of the heat transfer vessel to the inner shell of the heat transfer vessel, and thus to the substance when disposed within in the heat transfer vessel.

2. The device of claim 1, wherein the chamber is disposed at least partially within the sidewall portion of the heat transfer vessel.

3. The device of claim 2, wherein with the application of heat to the base portion of the heat transfer vessel, the heat transfer fluid facilitates transfer of thermal energy to the inner shell at the sidewall portion of the heat transfer vessel using phase change of the heat transfer fluid between liquid state and vapor state.

4. The device of claim 3, wherein the heat transfer fluid is selected based on defined phase change characteristics thereof to suit heating of the substance to a desired temperature employing a defined heat input.

5. The device of claim 1, wherein at least a portion of the heat transfer fluid is in liquid state and only partially fills the chamber in liquid state.

6. The device of claim 5, wherein a portion of the heat transfer fluid is in vapor state and partially fills the chamber of the heat transfer vessel.

7. The device of claim 1, wherein the chamber is disposed within both the base portion and the sidewall portion of the heat transfer vessel.

8. The device of claim 7, wherein when heat is applied to the base portion of the heat transfer vessel, the heat transfer fluid facilitates transfer of thermal energy to the inner shell at the sidewall portion of the heat transfer vessel using phase-change of the heat transfer fluid between liquid state and vapor state.

9. The device of claim 1, further comprising an insulative structure at least partially surrounding the outer shell of the heat transfer vessel at the sidewall portion thereof.

10. The device of claim 1, wherein the heat transfer vessel further comprises at least one protrusion in the inner shell thereof projecting into a central region of the heat transfer vessel to contain the substance to be heated, and wherein the chamber extends at least partially into the at least one protrusion in the inner shell of the heat transfer vessel, the at least one protrusion increasing surface area of the inner shell exposed to the chamber, thus facilitating transfer of heat to the substance when disposed within the heat transfer vessel.

11. The device of claim 10, wherein the at least one protrusion in the inner shell of the heat transfer vessel projects from the base portion thereof into the central region of the heat transfer vessel to contain the substance to be heated.

12. The device of claim 11, wherein the at least one protrusion comprises at least one rib-shaped protrusion in the inner shell of the heat transfer vessel projecting into the central region of the heat transfer vessel to contain the substance to be heated.

13. The device of claim 1, wherein the heat transfer vessel further comprises multiple protrusions in the inner shell thereof projecting into a central region of the heat transfer vessel to contain the substance to be heated to provide a larger surface area in contact with the substance, and wherein the chamber extends at least partially into the multiple protrusions in the inner shell to facilitate transfer of heat from the outer shell to the multiple protrusions in the inner shell, and thus to the substance when disposed within the heat transfer vessel.

14. The device of claim 13, wherein the multiple protrusions in the inner shell comprise multiple cylindrical-shaped protrusions in the inner shell projecting into the central region of the heat transfer vessel to contain the substance to be heated.

15. A method of fabricating a heat transfer vessel, the method comprising:
forming an at least partially hollow structure comprising a chamber defined between an outer shell and an inner shell thereof, and comprising a base portion and a sidewall portion extending from the base portion, the chamber being disposed within at least one of the base portion or the sidewall portion of the hollow structure; and
disposing a heat transfer fluid within the chamber of the hollow structure, the heat transfer fluid facilitating transfer of heat applied to the outer shell of the heat transfer vessel to the inner shell of the heat transfer vessel, and thus to a substance when disposed within the heat transfer vessel.

16. The method of claim 15, further comprising selecting the heat transfer fluid based on defined phase change characteristics thereof for repeated boiling and condensing with the application of a defined heat input to the outer shell of the heat transfer vessel, thereby facilitating transfer of heat from the outer shell to the inner shell, and thus to the substance when disposed within the heat transfer vessel.

17. The method of claim 16, wherein heat transfer fluid in liquid state within the chamber in contact with the outer shell boils with the applied heat to the outer shell, and heat transfer fluid in vapor state within the chamber in contact to the inner shell condenses, wherein the chamber is disposed at least partially within the sidewall portion of the heat transfer vessel and allows transport of vaporized heat transfer fluid up the sidewall portion of the heat transfer vessel to the inner shell thereof to facilitate heating of the substance when disposed within the heat transfer vessel.

18. The method of claim 15, wherein the forming further comprises forming at least one protrusion in the inner shell projecting into a central region of the heat transfer vessel to contain the substance, and wherein the chamber defined between the outer shell and the inner shell extends at least partially into the at least one protrusion in the inner shell, the at least one protrusion increasing surface area of the inner shell exposed to the chamber, thereby facilitating transfer of heat from the outer shell to the substance when disposed within the heat transfer vessel.

19. The method of claim 18, wherein the at least one protrusion comprises at least one rib-shaped protrusion in the inner shell projecting into the central region of the heat transfer vessel to contain the substance to be heated, and wherein the chamber defined between the outer shell and inner shell extends at least partially into the at least one rib-shaped protrusion in the inner shell.

20. The method of claim 15, wherein the forming further comprises forming multiple protrusions in the inner shell projecting into a central region of the heat transfer vessel to contain the substance to be heated to provide a larger surface area in contact with the substance, and wherein the chamber extends at least partially into the multiple protrusions in the inner shell to facilitate transfer of heat from the outer shell to the multiple protrusions in the inner shell, and thus, to the substance when disposed within the heat transfer vessel.
